(19) United States
(12) Patent Application Publication
(10) Pub. No.: US 2021/0041945 A1
(43) Pub. Date: Feb. 11, 2021

(54) MACHINE LEARNING BASED GAZE ESTIMATION WITH CONFIDENCE

(71) Applicant: Tobii AB, Danderyd (SE)

(72) Inventor: Geoffrey Cooper, Danderyd (SE)

(73) Assignee: Tobii AB, Danderyd (SE)

(21) Appl. No.: 16/906,120

(22) Filed: Jun. 19, 2020

(30) Foreign Application Priority Data
Jun. 19, 2019 (SE) 1950727-6

(51) Int. Cl. G06F 3/01; G06T 7/246; G06T 7/11; G06T 7/174; G02B 27/00; G02B 27/01

(52) U.S. Cl. CPC G06F 3/013; G06F 3/017; G06T 7/248; G06T 7/11; G06T 2207/20132; G02B 27/0093; G02B 27/0172; G06T 2207/10028; G06T 7/174

(57) ABSTRACT

An eye tracking system, a head mounted device, a computer program, a carrier and a method in an eye tracking system for determining a refined gaze point of a user are disclosed. In the method a gaze convergence distance of the user is determined. Furthermore, a spatial representation of at least a part of a field of view of the user is obtained and depth data for at least a part of the spatial representation are obtained. Saliency data for the spatial representation are determined based on the determined gaze convergence distance and the obtained depth data, and a refined gaze point of the user is determined based on the determined saliency data.

### CROSS REFERENCE TO RELATED APPLICATIONS

This application claims priority to Swedish Application No. 1950758-1, filed Jun. 19, 2019; the content of which are hereby incorporated by reference.

### TECHNICAL FIELD

The present disclosure relates to the field of eye tracking. In particular, the present disclosure relates to a method and system determining a refined gaze point of a user.

### BACKGROUND

Eye/gaze tracking functionality is included in increasing number of applications, such as virtual reality (VR) and augmented reality (AR) applications. By inclusion of such eye tracking functionality, an estimated gaze point of a user can be determined which in turn can be used as input to other functions.

When determining an estimated gaze point of a user in an eye tracking system, a jitter may arise in the signal representing the estimated gaze point of the user e.g. due to measurement errors in the eye tracking system. Different gaze points of the user may be determined in different measuring cycles over a period even though the user is actually focusing on the same point over that period. In US 2016/0291690 A1, saliency data for a field of view of a user are used together with eye gaze direction of the user to more reliably determine a point of interest at which the user is gazing. However, determining saliency data for a field of view of a user requires processing and even if the saliency data are used, the point of interest determined may differ from the actual point of interest.

It would be desirable to provide an eye tracking technology that provides a more robust and accurate gaze point than the known methods.

### SUMMARY

An object of the present disclosure is to provide a method and system, which seek to mitigate, alleviate, or eliminate one or more of the above-identified deficiencies in the art.

This object is obtained by a method, an eye tracking system, a head mounted device, a computer program and a carrier according to the appended claims.

According to an aspect, a method in an eye tracking system for determining a refined gaze point of a user is provided. In the method, a gaze convergence distance of the user is determined, a spatial representation of at least a part of a field of view of the user is obtained, and depth data for at least a part of the spatial representation are obtained. Saliency data are determined for the spatial representation based on the determined gaze convergence distance and the obtained depth data, and a refined gaze point of the user is then determined based on the determined saliency data.

Saliency data provide a measure to attributes in the user's field of view and represented in the spatial representation indicating the attributes' likelihood to guide human visual attention. Determining saliency data for the spatial representation means that saliency data relating to at least a portion of the spatial representation are determined.

The depth data for the at least a part of the spatial representation indicate distances from the user's eyes to objects or features in the field of view of the user corresponding to the at least a part of the spatial representation. Depending on the application, e.g. AR or VR, the distances are real or virtual.

The gaze convergence distance indicates a distance from the user's eyes at which a user is focusing. The convergence distance can be determined using any method of determining convergence distance, such as methods based on gaze directions of the user's eyes and intersection between the directions or methods based on interpupillary distance.

Basing the determination of saliency data also on the determined gaze convergence distance and the obtained depth data for at least a part of the spatial representation, enables determining the saliency data faster and with less required processing. It further enables determining of a refined gaze point of the user that is a more accurate estimate of a point of interest of the user.

In embodiments, determining saliency data for the spatial representation comprises identifying a first depth region of the spatial representation corresponding to obtaining depth data within a predetermined range including the determined gaze convergence distance. Saliency data are then determined for the first depth region of the spatial representation.

The identified first depth region of the spatial representation corresponds to objects or features in the at least a part of the field of view of the user which are within the predetermined range including the determined gaze convergence distance. It is generally more likely that the user is looking at one of these objects or features than at objects or features corresponding to regions of the spatial representation with depth data outside the predetermined range. Consequently, it is beneficial to determine saliency data for the first depth region and to determine a refined gaze point based on the determined saliency data.

In embodiments, determining saliency data for the spatial representation comprises identifying a second depth region of the spatial representation corresponding to obtained depth data outside the predetermined range including the gaze convergence distance, and refraining from determining saliency data for the second depth region of the spatial representation.

The identified second depth region of the spatial representation corresponds to objects or features in the at least a part of the field of view of the user which are outside the predetermined range including the determined gaze convergence distance. It is generally less likely that the user is looking at one of these objects or features than at objects or features corresponding to regions of the spatial representation with depth data inside the predetermined range. Consequently, it is beneficial to refrain from determining saliency data for the second depth region in order to avoid processing which is likely to be unnecessary or may even provide misleading results since the user is not likely looking at the objections and/or features corresponding to regions of the spatial representation with depth data outside the predetermined range. This will reduce used processing power for determining saliency data in relation to methods where saliency data are also determined without taking determined gaze convergence distance of the user and depth data for at least a part of the spatial representation.

In embodiments, determining a refined gaze point comprises determining the refined gaze point of the user as a point corresponding to a highest saliency according to the determined saliency data. A determined refined gaze point will thus be a point that in some respect is most likely to draw visual attention. Used together with determining saliency data for an identified first depth region of the spatial representation corresponding to obtained depth data within a predetermined range including the determined gaze convergence distance, a determined refined gaze point will thus be a point that in some respect is most likely to draw visual attention within the first depth region.

In embodiments, determining saliency data for the spatial representation comprises determining first saliency data for of the spatial representation based on visual saliency, determining second saliency data for the spatial representation based on the determined gaze convergence distance and the obtained depth data, and determining saliency data based on the first saliency data and the second saliency data. The first saliency data may for example be based on high contrast, vivid colour, size, motion etc. The different types of saliency data are combined after optional normalisation and weighting.

In embodiments, the method further comprises determining a new gaze convergence distance of the user, determining new saliency data for the spatial representation based on the new gaze convergence distance, and determining a refined new gaze point of the user based on the new saliency data. Hence, a dynamic refined new gaze point can be determined based on new gaze convergence distances determined over time. Several alternatives are contemplated such as for example using only a current determined new gaze convergence distance or a mean of gaze convergence points determined over a predetermined period.

In embodiments, the method further comprises determining a plurality of gaze points of the user, and identifying a cropped region of the spatial representation based on the determined plurality of gaze points of the user. Preferably, determining saliency data then comprises determining saliency data for the identified cropped region of the spatial representation.

It is generally more likely that the user is looking at a point corresponding to the cropped region than at points corresponding to regions outside the cropped region. Consequently, it is beneficial to determine saliency data for the cropped region and to determine a refined gaze point based on the determined saliency data.

In embodiments, the method further comprises refraining from determining saliency data for regions of the spatial representation outside the identified cropped region of the spatial representation.

It is generally less likely that the user is looking at a point corresponding to regions outside the cropped region than at points corresponding to the cropped region. Consequently, it is beneficial to refrain from determining saliency data for the regions outside the cropped region in order to avoid processing which is likely to be unnecessary or may even provide misleading results since the user is not likely looking at points corresponding to regions outside the cropped region. This will reduce used processing power for determining saliency data in relation methods where saliency data are also determined without cropping based on determined gaze points of the user.

In embodiments, obtaining depth data comprises obtaining depth data for the identified cropped region of the spatial representation. By obtaining depth data for the identified cropped region, and not necessarily depth data for regions outside the cropped region, saliency data can be determined within the cropped region and based on the obtained depth data for the identified cropped region only. Hence, the amount of processing needed can be reduced further for determining saliency data.

In embodiments, the method further comprises determining a respective gaze convergence distance for each of the plurality of determined gaze points of the user.

In embodiments, the method further comprises determining a new gaze point of the user. On condition that the determined new gaze point is within the identified cropped region, identifying a new cropped region being the same as the identified cropped region. In alternative, on condition that the determined new gaze point is outside the identified cropped region, identifying a new cropped region including the determined new gaze point and being different from the identified cropped region.

If the new determined gaze point of the user is determined to be within the identified cropped region, the user is likely to look at a point within the cropped region. By maintaining the same cropped region in such a case, any determined saliency data based on the identified cropping region can be used again. Hence, no further processing is needed for determining saliency based on the identified cropping region.

In embodiments, consecutive gaze points of the user are determined in consecutive time intervals, respectively. Furthermore, for each time interval, it is determined if the user is fixating or saccading. On condition the user is fixating a refined gaze point is determined. On condition the user is saccading, determining a refined gaze point is refrained from. If the user is fixating it is likely that the user is looking at a point at that time and hence, a refined gaze point is likely relevant to determine. If on the other hand, the user is saccading, the user is not likely looking at a point at that time and hence, a refined gaze point is not likely relevant to determine. These embodiments will enable reduction of processing whilst at the same time determine a refine gaze point if it is likely that such a determining is relevant to determine.

In embodiments, consecutive gaze points of the user are determined in consecutive time intervals, respectively. Furthermore, for each time interval it is determined if the user is in smooth pursuit. On condition the user is in smooth pursuit, consecutive cropped regions including the consecutive gaze points, respectively, are determined such that the identified consecutive cropped regions follow the smooth pursuit. If smooth pursuit is determined, consecutive cropped regions can be determined with little additional processing needed if cropped regions are determined to follow the smooth pursuit.

In embodiments, the spatial representation is an image, such as a 2D image of the real world, 3D image of the real world, 2D image of a virtual environment, or 3D image of a virtual environment. The data could come from a photo sensor, a virtual 3D scene, or potentially another type of image sensor or spatial sensor.

According to a second aspect, an eye tracking system for determining a gaze point of a user is provided. The eye tracking system comprises a processor and a memory, said memory containing instructions executable by said processor. The eye tracking system is operative to determine a gaze convergence distance of the user and obtain a spatial representation if at least a part of a field of view of the user. The eye tracking system is further operative to obtain depth data for at least a part of the spatial representation, and determine saliency data for the spatial representation based on the determined gaze convergence distance and the obtained depth data. The eye tracking system is further operative to determine a refined gaze point of the user based on the determined saliency data.

Embodiments of the eye tracking system according to the second aspect may for example include features corresponding to the features of any of the embodiments of the method according to the first aspect.

According to a third aspect, a head mounted device for determining a gaze point of a user is provided. The head mounted device comprises a processor and a memory, said memory containing instructions executable by said processor. The head mounted device is operative to determine a gaze convergence distance of the user, and obtain a spatial representation of at least a part of a field of view of the user. The head mounted device is further operative to obtain depth data for at least a part of the spatial representation, and determine saliency data for the spatial representation based on the determined gaze convergence distance and the obtained depth data. The head mounted device is further operative to determine a refined gaze point of the user based on the determined saliency data.

In embodiments, the head mounted device further comprises one of a transparent display and a non-transparent display.

Embodiments of the head mounted device according to the third aspect may for example include features corresponding to the features of any of the embodiments of the method according to the first aspect.

According to a fourth aspect, a computer program is provided. The computer program comprising instructions which, when executed by at least one processor, cause the at least one processor to determine a gaze convergence distance of the user, and obtain a spatial representation of a field of view of the user. The at least one processor is further caused to obtain depth data for at least a part of the spatial representation, and determine saliency data for the spatial representation based on the determined gaze convergence distance and the obtained depth data. The at least one processor is further caused to determine a refined gaze point of the user based on the determined saliency data.

Embodiments of the computer program according to the fourth aspect may for example include features corresponding to the features of any of the embodiments of the method according to the first aspect.

According to a fifth aspect, a carrier comprising a computer program according to the fourth aspect is provided. The carrier is one of an electronic signal, optical signal, radio signal, and a computer readable storage medium.

Embodiments of the carrier according to the fifth aspect may for example include features corresponding to the features of any of the embodiments of the method according to the first aspect.

### BRIEF DESCRIPTION OF THE DRAWINGS

These and other aspects will now be described in the following illustrative and non-limiting detailed description, with reference to the appended drawings.

FIG. 1 is a flowchart illustrating embodiments of a method according to the present disclosure.

FIG. 2 includes images illustrating results from steps of embodiments of a method according to the present disclosure.

FIG. 3 is a flowchart illustrating steps of a method according to the present disclosure.

FIG. 4 is a flowchart illustrating further steps of a method according to the present disclosure.

FIG. 5 is a flowchart illustrating yet further steps of a method according to the present disclosure.

FIG. 6 is a block diagram illustrating embodiments of an eye tracking system according to the present disclosure.

All the figures are schematic, not necessarily to scale, and generally only show parts which are necessary in order to elucidate the respective example, whereas other parts may be omitted or merely suggested.

### DETAILED DESCRIPTION

Aspects of the present disclosure will be described more fully hereinafter with reference to the accompanying drawings. The method, the eye tracking system, the head mounted device, the computer program and the carrier disclosed herein can, however, be realized in many different forms and should not be construed as being limited to the aspects set forth herein. Like numbers in the drawings refer to like elements throughout.

Saliency data provide a measure to attributes in the user's field of view and represented in the spatial representation indicating the attributes' likelihood to guide human visual attention. Some of the most likely attributes to do so are, for example, colour, motion, orientation, and scale. A saliency model can be used to determine such saliency data. Saliency models typically predict what attracts human visual attention. Many saliency models determines saliency data for a region based e.g. how different the region is from what surrounds it, based on a model of a biologically plausible set of features that mimic early visual processing.

In a spatial representation of a field of view of a user, a saliency model can be used to identify different visual features that to different extent contribute to the attentive selection of a stimulus, and produce saliency data indicating saliency of different points in the spatial representation. Based on the determined saliency data, a refined gaze point can then be determined that more likely correspond to a point of interest at which the user is gazing.

When saliency data are determined in a saliency model, on, for example a spatial representation in the form of a 2D image, each pixel of the image may be analysed for how salient it is according to a certain visual attribute, and each pixel is assigned a saliency value for that attribute. Once saliency is calculated for each pixel, the difference in saliency between pixels is known. Optionally, salient pixels may then be grouped together into salient regions to simplify the feature result.

Prior art saliency models typically use a bottom-up approach to calculate saliency, using an image as input to the model. The inventor has realized that additional top-down, determined information about a user from an eye tracking system can be used in order to achieve a more accurate estimate of the point of interest at which the user is gazing and/or make the saliency model to run faster. Top-down information provided by the eye tracker may be one or more determined gaze convergence distances of the user. Further top-down information provided by the eye tracker may be one or more determined gaze points of the user. Saliency data are then determined for the spatial representation based on the top down information.

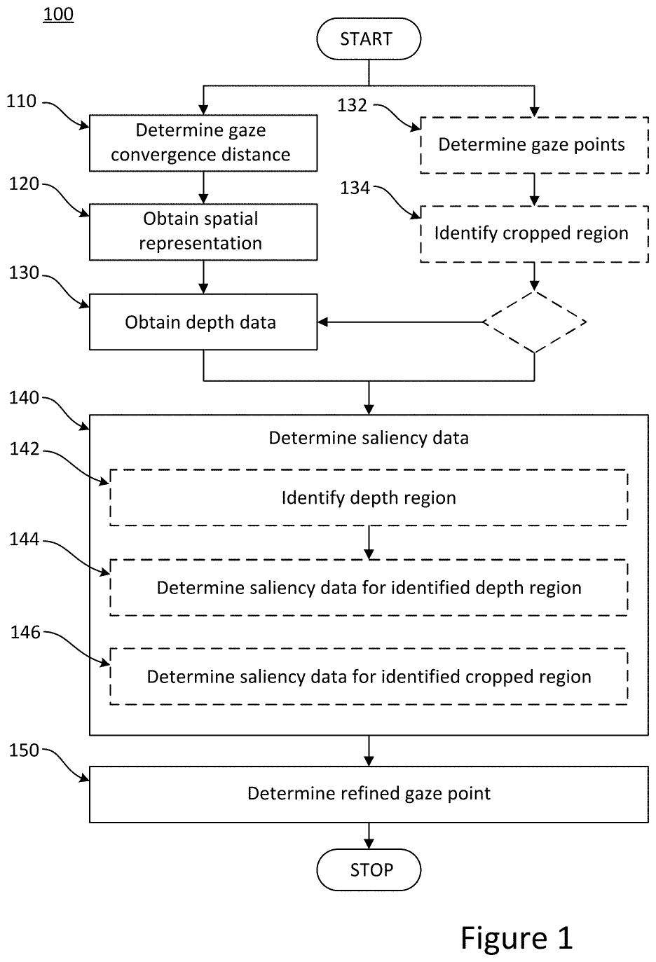

FIG. 1 is a flowchart illustrating embodiments of a method 100 in an eye tracking system for determining a refined gaze point of a user. In the method a gaze convergence distance of the user is determined 110. The gaze convergence distance indicates a distance from the user's eyes at which a user is focusing. The convergence distance can be determined using any method of determining convergence distance, such as methods based on gaze directions of the user's eyes and intersection between the directions, methods based on time of flight measurements, and methods based on interpupillary distance. The eye tracking system in which the method 100 is performed in may e.g. be a head mounted system, such as augmented reality (AR) glasses or virtual reality (VR) glasses, but could also be an eye tracking system that is not head mounted but rather remote from the user. Further, the method comprises the step of obtaining 120 a spatial representation of at least a part of a field of view of the user. The spatial representation could for example be a digital image of at least a part of the field of view of the user captured by one or more cameras in or remote from the eye tracking system. Furthermore, depth data for at least a part of the spatial representation are obtained 130. Depth data for the spatial representation of the user's field of view indicate real or virtual distances from the user's eyes to points of parts of objects or features in the field of view of the user. The depth data are linked to points or parts of the spatial representation corresponding to the points of parts of objects or features of the field of view of the user, respectively. Hence, a point in or region of the spatial representation which is a representation of a point on or part of an object or feature in the field of view of the user will have depth data indicating the distance from the user's eyes to the point on or part of the object or feature. For example, the spatial representation may be two images (stereo images) taken from two outward facing cameras at a lateral distance in a head mounted device. A distance from the user's eyes to points or parts of objects or features in the field of view of the user can then be determined by analysis of the two images. The thus determined depth data can be linked to points or parts of the two images corresponding to the points of parts of the objects or features in the field of view of the user, respectively. Other examples of spatial representations are possible, such as 3D mesh based on Time-of-flight measurements or simultaneous localization and mapping (SLAM). Based on the determined gaze convergence distance and the obtained depth data, saliency data are determined 140 for the spatial representation. Finally, a refined gaze point of the user is then determined 150 based on the determined saliency data.

Depending on the application, depth data for the spatial representation of the user's field of view indicate real or virtual distances from the user's eyes to points or parts of objects or features in the field of view. In applications where the spatial representation includes representations of real world objects or features of at least part of the field of view of the user, the distances indicated by depth data are typically real, i.e. they indicate real distances from the user's eyes to the real world objects or features represented in the spatial representation. In applications where the spatial representation includes representations of virtual objects or features of at least part of the field of view of the user, the distances indicated by depth data are typically virtual as the user perceives them, i.e. they indicate virtual distances from the user's eyes to the virtual objects or features represented in the spatial representation.

The determined gaze convergence distance and the obtained depth data can be used to enhance the determining of saliency data such that they provide refined information on which the determining of the refined gaze point can be based. For example, one or more regions of the spatial representation can be identified that correspond to parts of objects or features in the field of view with distances from the users eyes that are consistent with the determined gaze convergence distance. The identified one or more regions can be used to refine the saliency data by adding information indicating which regions of the spatial representation are more likely to correspond to a point of interest at which the user is gazing. Furthermore, the identified one or more regions of the spatial representation can be used as form of filter before saliency data are determined for the spatial representation. In this way, saliency data are determined only for such regions of the spatial representation that correspond to parts of objects or features in the field of view with distances from the users eyes that are consistent with the determined gaze convergence distance.

Specifically, determining 140 saliency data for the spatial representation can comprise identifying 142 a first depth region of the spatial representation corresponding to obtained depth data within a predetermined range including the determined gaze convergence distance. The range can be set to be broader or narrower depending on e.g. the accuracy of the determined gaze convergence distance, the accuracy of obtained depth data and on other factors. Saliency data are then determined 144 for the first depth region of the spatial representation.

The identified first depth region of the spatial representation corresponds to objects or features in the at least a part of the field of view of the user which are within the predetermined range including the determined gaze convergence distance. It is generally more likely that the user is looking at one of these objects or features than at objects or features corresponding to regions of the spatial representation with depth data outside the predetermined range. Consequently, identification of the first depth region provides further information useful for identifying a point of interest at which the user is gazing.

In addition to determining the first depth region, determining saliency data for the spatial representation preferably comprises identifying a second depth region of the spatial representation corresponding to obtained depth data outside the predetermined range including the gaze convergence distance. In contrast to the first depth region, no saliency data are determined for the second depth region of the spatial representation. Instead, after identification of the second depth region, the method explicitly refrains from determining saliency data for the second depth region.

The identified second depth region of the spatial representation corresponds to objects or features in the at least a part of the field of view of the user which are outside the predetermined range including the determined gaze convergence distance. It is generally less likely that the user is looking at one of these objects or features than at objects or features corresponding to regions of the spatial representation with depth data inside the predetermined range. Consequently, it is beneficial to refrain from determining saliency data for the second depth region in order to avoid processing which is likely to be unnecessary or may even provide misleading results since the user is not likely looking at the objections and/or features corresponding to regions of the spatial representation with depth data outside the predetermined range.

Typically, the method 100 is performed repeatedly to produce new refined gaze points over time as the point of interest the user is gazing at is normally changed over time. The method 100 thus typically further comprises determining a new gaze convergence distance of the user, determining new saliency data for the spatial representation based on the new gaze convergence distance, and determining a refined new gaze point of the user based on the new saliency data. Hence, a dynamic refined new gaze point is be determined based on new gaze convergence distances determined over time. Several alternatives are contemplated such as for example using only a current determined new gaze convergence distance or a mean of gaze convergence points determined over a predetermined period. Furthermore, if the user's field of view also changes over time, a new spatial representation is obtained and new depth data for at least a part of the new spatial representation are obtained.

Additional top-down information provided by the eye tracker may be one or more determined gaze points of the user. The method 100 may further comprise determining 132 a plurality of gaze points of the user, and identifying 134 a cropped region of the spatial representation based on the determined plurality of gaze points of the user. The plurality of gaze points are generally determined over a period. The determined individual gaze points of the determined plurality of gaze points may typically differ from each other. This may be due to the user looking at different points over the period but could also be due to errors in the determined individual gaze points, i.e. the user may actually be looking at the same point over the period but the determined individual gaze points still differ from each other. The cropped region preferably includes all of the determined plurality of gaze points. The size of the cropped region may depend e.g. on accuracy of determined gaze points such that higher accuracy will lead to a smaller cropped region.

It is generally more likely that the user is looking at a point corresponding to the cropped region than at points corresponding to regions outside the cropped region. Consequently, it is beneficial to determine saliency data for the cropped region and to determine a refined gaze point based on the determined saliency data. Furthermore, since it is more likely that the user is looking at a point corresponding to the cropped region than at points corresponding to regions outside the cropped region, determining saliency data for regions of the spatial representation outside the identified cropped region of the spatial representation can be refrained from. Each region of the spatial representation outside the identified cropped region for which saliency data are not determined, will reduce the amount of processing needed in relation to determining saliency data for all regions of the spatial representation. Generally, the cropped region can be made substantially smaller than the whole of the spatial representation whilst the probability that the user is looking at a point within the cropped region is maintained high. Hence, refraining from determining saliency data for regions of the spatial representation outside the cropped region can reduce the amount of processing substantially.

In addition or alternative to using the identified cropped region in determining of saliency data, the cropped region can be used when obtaining depth data. For example, since it is more likely that the user is looking at a point corresponding to the cropped region than at points corresponding to regions outside the cropped region, depth data can be obtained for the identified cropped region, and not necessarily for regions outside the cropped region. Saliency data can then be determined within the cropped region and based on the obtained depth data for the identified cropped region only. Hence, the amount processing needed for obtaining depth data and determining saliency data can be reduced.

The method 100 may further comprise determining at least a second gaze convergence distance of the user. The first depth region of the spatial representation is then identified corresponding to depth data within a range determined based on said determined gaze convergence distance and the determined at least second gaze convergence distance. Saliency data are then determined for the first depth region of the spatial representation.

The identified first depth region of the spatial representation corresponds to objects or features in the at least a part of the field of view of the user which are within a range determined based on the determined gaze convergence distance and the determined at least second gaze convergence distance. It is generally more likely that the user is looking at one of these objects or features than at objects or features corresponding to regions of the spatial representation with depth data outside the range. Consequently, identification of the first depth region provides further information useful for identifying a point of interest at which the user is gazing.

There are several alternatives for determining the range based on the determined gaze convergence distance and the determined at least second gaze convergence distance. In a first example, a maximum gaze convergence distance and a minimum gaze convergence distance of the determined gaze convergence distance and the determined at least second gaze convergence distance may be determined. The maximum and minimum gaze convergence distances may then be used to identify the first depth region of the spatial representation corresponding to obtained depth data within a range including the determined maximum and minimum gaze convergence distances. The range can be set to be broader or narrower depending on e.g. the accuracy of the determined gaze convergence distances, the accuracy of obtained depth data and on other factors. As an example, the range can be set to be from the determined minimum gaze convergence distance to the maximum gaze convergence distance. Saliency data are then determined for the first depth region of the spatial representation.

In the first example, the identified first depth region of the spatial representation corresponds to objects or features in the at least a part of the field of view of the user which are within a range including the determined maximum and minimum gaze convergence distances. It is generally more likely that the user is looking at one of these objects or features than at objects or features corresponding to regions of the spatial representation with depth data outside the range. Consequently, identification of the first depth region according to the first example provides further information useful for identifying a point of interest at which the user is gazing.

In a second example, a mean gaze convergence distance of the determined gaze convergence distance and the determined at least second gaze convergence distance of the user may be determined. The mean gaze convergence distance may then be used to identify the first depth region of the spatial representation corresponding to obtained depth data within a range including the determined mean gaze convergence distances. The range can be set to be broader or narrower depending on e.g. the accuracy of the determined gaze convergence distance, the accuracy of obtained depth data and on other factors. Saliency data may then determined for the first depth region of the spatial representation.

In the second example, the identified first depth region of the spatial representation corresponds to objects or features in the at least a part of the field of view of the user which are within the range including the mean gaze convergence distance. It is generally more likely that the user is looking at one of these objects or features than at objects or features corresponding to regions of the spatial representation with depth data outside the range. Consequently, identification of the first depth region according to the second example provides further information useful for identifying a point of interest at which the user is gazing.

The refined gaze point of the user can be determined 150 as a point corresponding to a highest saliency according to the determined saliency data. A determined refined gaze point will thus be a point that in some respect is most likely to draw visual attention. Used together with determining 144 saliency data for an identified first depth region of the spatial representation corresponding to obtained depth data within a predetermined range including the determined gaze convergence distance, a determined refined gaze point will thus be a point that in some respect is most likely to draw visual attention within the first depth region. This can be further combined with identifying 132 a plurality of gaze points and identifying 134 a cropped region comprising the determined plurality of gaze points and obtaining 130 depth data for only the cropped region. Furthermore, saliency data may be determined 146 only for the identified cropped region and optionally only for the identified depth region or combined with saliency data for the identified depth region such that saliency data are produced only for the depth region within the cropped region. A determined refined gaze point will thus be a point that in some respect is most likely to draw visual attention within the first depth region within the cropped region.

Determining saliency data for the spatial representation may comprise determining first saliency data for of the spatial representation based on visual saliency, determining second saliency data for the spatial representation based on the determined gaze convergence distance and the obtained depth data, and determining saliency data based on the first saliency data and the second saliency data. Visual saliency is an ability of an item or an item in an image to attract visual attention (bottom-up, i.e. the value is not known but could be guessed from algorithms). In more detail, visual saliency is a distinct subjective perceptual quality that makes some items in the world stand out from their neighbours and immediately grab our attention. The visual saliency may be based on colour, contrast, shape, orientation, motion or any other perceptual characteristic.

Once saliency data have been computed for the different saliency features, such as the visual saliency and depth saliency based on determined gaze convergence distance and the obtained depth data, they may be normalized and combined to form a master saliency result. Depth saliency relates to the depth at which the user is looking (top-down, i.e. the value is known). Distances conforming with a determined convergence distance are considered to be more salient. When combining saliency features, each feature can be weighted equally or have different weights according to which features are estimated to have the most impact on visual attention and/or which features had the highest maximum saliency value compared to an average or expected value. The combination of saliency features may be determined by a Winner-Take-All mechanism. Optionally, the master saliency result can be translated into a master saliency map: a topographical representation of overall saliency. This is a useful step for the human observer, but not necessary if the saliency result is used as input for a computer program. In the master saliency result, a single spatial location should stand out as most salient.

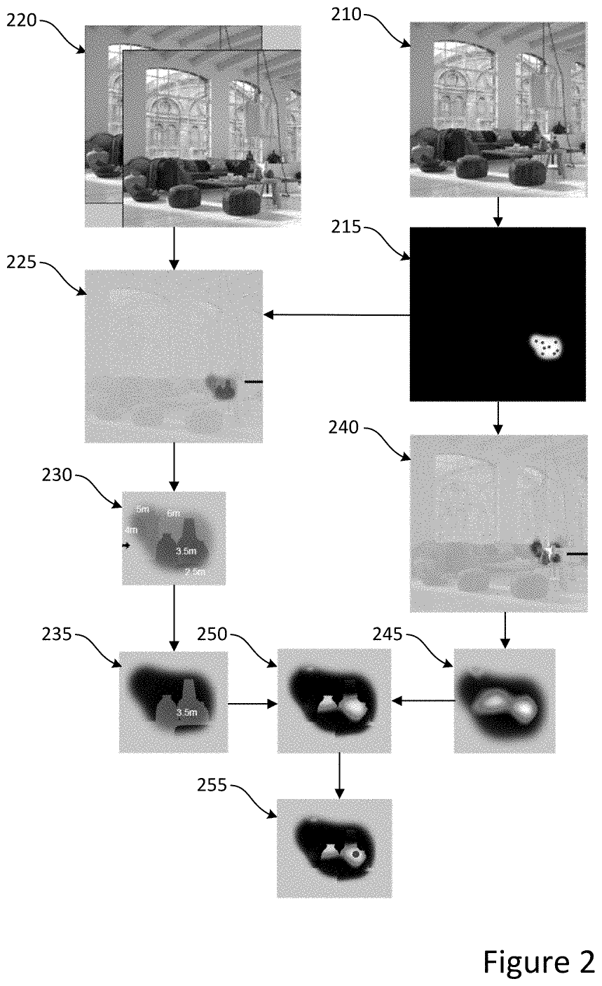

FIG. 2 includes images illustrating results from steps of embodiments of a method according to the present disclosure. A spatial representation of at least a part of a user's field of view in the form of an image 210 is input to a method for determining a refined gaze point. A plurality of gaze points are determined in the image 210, and a cropped region including the plurality of determined gaze points is identified as illustrated in an image 215. Furthermore, stereo images 220 is obtained for the at least part of the user's field of view is received and the cropped region is identified as illustrated in an image 225 and depth data are obtained for the cropped region based on the stereo images 220 as illustrated in an image 230. A gaze convergence distance of the user is then received, which for the present example is 3.5 m, and a first depth region is determined as a region in the cropped region that corresponds to depth data within a range around the gaze convergence distance. In the present example, the range is 3 m<x<4 m and the resulting first depth region is illustrated in an image 235. Visual saliency is determined for the cropped region illustrated in 240 to produce saliency data illustrated in the form of a saliency map 245 of the cropped region. The saliency map 245 and the first depth region illustrated in the image 235 are combined to a saliency map 250 for the first depth region within the cropped region. A refined gaze point is the point identified as the point with highest saliency in the first depth region within the cropped region. This point is illustrated as a black dot in an image 255.

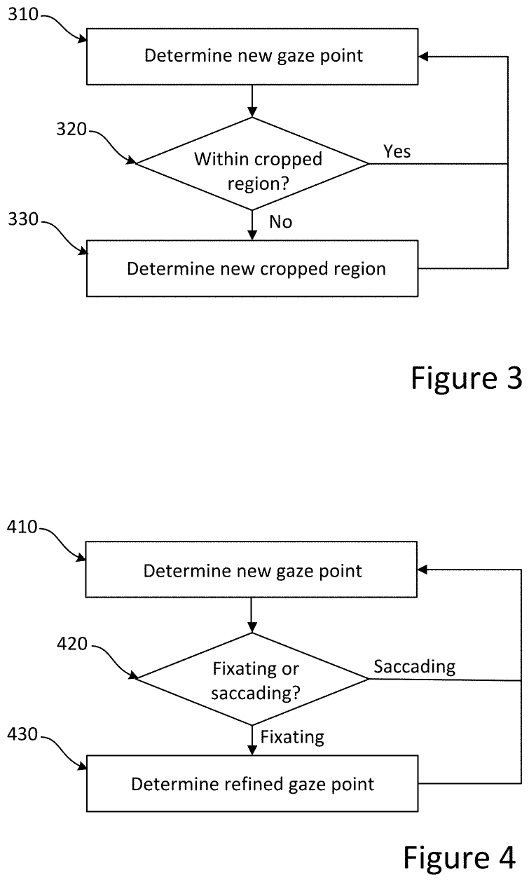

FIG. 3 is a flowchart illustrating steps of a method according to the present disclosure. Generally, the flowchart illustrates steps in relation to identifying cropped regions over time based on new determined gaze points, for example in relation to embodiments of a method as illustrated in FIG. 1. An identified cropped region is a cropped region that has been previously identified based on a plurality of previously determined gaze points. A new gaze point is then determined 310. On condition 320 that the determined new gaze point is within the identified cropped region, the identified cropped region is not changed but is continued to be used and a new gaze point is determined 310. An alternative way of seeing this is that a new cropped region is determined to be the same as the identified cropped region. On condition 320 that the determined new gaze point is not inside the identified cropped region, i.e. outside the identified cropped region, a new cropped region is determined 330 comprising the determined new gaze point. In this case the new cropped region will be different from the identified cropped region.

FIG. 4 is a flowchart illustrating further steps of a method according to the present disclosure. Generally, the flowchart illustrates steps in relation to determine refined gaze points over time based on new determined gaze points, for example in relation to embodiments of a method as illustrated in FIG. 1. Consecutive gaze points of the user are determined 410 in consecutive time intervals, respectively. Furthermore, for each time interval, it is determined 420 if the user is fixating or saccading. On condition 420 the user is fixating, a refined gaze point is determined 430. On condition 420 the user is saccading, determining a refined gaze point is refrained from. If the user is fixating it is likely that the user is looking at a point at that time and hence, a refined gaze point is likely relevant to determine. If on the other hand, the user is saccading, the user is not likely looking at a point at that time and hence, a refined gaze point is not likely relevant to determine. In relation to FIG. 1, this could for example mean that the method 100 will only be performed in case it is determined that the user is fixating.

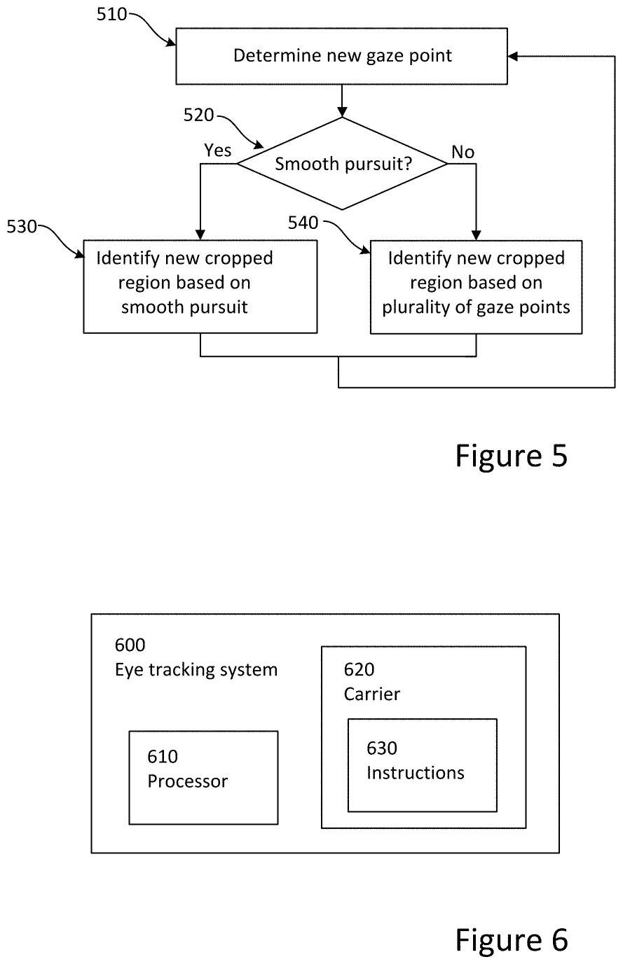

FIG. 5 is a flowchart illustrating yet further steps of a method according to the present disclosure. Generally, the flowchart illustrates steps in relation to identifying cropped regions over time based on determined gaze points, for example in relation to embodiments of a method as illustrated in FIG. 1. An identified cropped region is a cropped region that has been previously identified based on a plurality of previously determined gaze points. Consecutive gaze points of the user are determined 510 in consecutive time intervals, respectively. Furthermore, for each time interval it is determined 520 if the user is in smooth pursuit. On condition 520 the user is in smooth pursuit, a new cropped region is determined 530 based on the smooth pursuit. If smooth pursuit is determined, consecutive cropped regions can be determined with little additional processing needed if cropped regions are determined to follow the smooth pursuit. For example, the consecutive cropped regions can have the same shape and simply be moved in relation to each other in the same direction and speed as the smooth pursuit of the user. On condition 520 the user is not in smooth pursuit, a new cropped region including a plurality of gaze points comprising the determined new gaze point, is determined.

In embodiments, the spatial representation is an image, such as a 2D image of the real world, 3D image of the real world, 2D image of a virtual environment, or 3D image of a virtual environment. The data could come from a photo sensor, a virtual 3D scene, or potentially another type of image sensor or spatial sensor.

FIG. 1 comprises some steps that are illustrated in boxes with a solid border and some steps that are illustrated in boxes with a dashed border. The steps that are comprised in boxes with a solid border are operations that are comprised in the broadest example embodiment. The steps that are comprised in boxes with a dashed border are example embodiments that may be comprised in, or a part of, or are further operations that may be taken in addition to the operations of the border example embodiments. The steps do not all need to be performed in order and not all of the operations need to be performed. Furthermore, at least some of the steps may be performed in parallel.

Methods of for determining a refined gaze point of a user and steps therein as disclosed herein, e.g. in relation to FIGS. 1-5, may be implemented in an eye tracking system 600, e.g. implemented in a head mounted device, of FIG. 6. The eye tracking system 600 comprises a processor 610, and a carrier 620 including computer executable instructions 630, e.g. in the form of a computer program, that, when executed by the processor 610, cause the eye tracking system 600 to perform the method. The carrier 620 may for example be an electronic signal, optical signal, radio signal, a transitory computer readable storage medium, and a non-transitory computer readable storage medium.

A person skilled in the art realizes that the present invention is by no means limited to the embodiments described above. On the contrary, many modifications and variations are possible within the scope of the appended claims.

Additionally, variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The terminology used herein is for the purpose of describing particular aspects of the disclosure only, and is not intended to limit the invention. The division of tasks between functional units referred to in the present disclosure does not necessarily correspond to the division into physical units; to the contrary, one physical component may have multiple functionalities, and one task may be carried out in a distributed fashion, by several physical components in cooperation. A computer program may be stored/distributed on a suitable non-transitory medium, such as an optical storage medium or a solid-state medium supplied together with or as part of other hardware, but may also be distributed in other forms, such as via the Internet or other wired or wireless telecommunication systems. The mere fact that certain measures/features are recited in mutually different dependent claims does not indicate that a combination of these measures/features cannot be used to advantage. Method steps need not necessarily be performed in the order in which they appear in the claims or in the embodiments described herein, unless it is explicitly described that a certain order is required. Any reference signs in the claims should not be construed as limiting the scope.

1. A method in an eye tracking system for determining a refined gaze point of a user comprising:
determining a gaze convergence distance of the user;
obtaining a spatial representation of at least a part of a field of view of the user;
obtaining depth data for at least a part of the spatial representation;
determining saliency data for the spatial representation based on the determined gaze convergence distance and the obtained depth data; and
determining a refined gaze point of the user based on the determined saliency data.

2. The method of claim 1, wherein determining saliency data for the spatial representation comprises:
identifying a first depth region of the spatial representation corresponding to obtained depth data within a predetermined range including the determined gaze convergence distance; and
determining saliency data for the first depth region of the spatial representation.

3. The method of claim 1, wherein determining saliency data for the spatial representation comprises:
identifying a second depth region of the spatial representation corresponding to obtained depth data outside the predetermined range including the gaze convergence distance; and
refraining from determining saliency data for the second depth region of the spatial representation.

4. The method of claim 1, wherein determining a refined gaze point comprises:
determining the refined gaze point of the user as a point corresponding to a highest saliency according to the determined saliency data.

5. The method of claim 1, wherein determining saliency data comprises:
determining first saliency data for the spatial representation based on visual saliency;
determining second saliency data for the spatial representation based on the determined gaze convergence distance and the obtained depth data; and
determining saliency data based on the first saliency data and the second saliency data.

6. The method of claim 1, further comprising:
determining a new gaze convergence distance of the user;
determining new saliency data for the spatial representation based on the new gaze convergence distance; and
determining a refined new gaze point of the user based on the new saliency data.

7. The method of claim 1, further comprising:
determining a plurality of gaze points of the user; and
identifying a cropped region of the spatial representation based on the determined plurality of gaze points of the user.

8. The method of claim 7, wherein determining saliency data comprises:
determining saliency data for the identified cropped region of the spatial representation.

9. The method of claim 7, further comprising:
refraining from determining saliency data for regions of the spatial representation outside the identified cropped region of the spatial representation.

10. The method of claim 7, wherein obtaining depth data comprises:
obtaining depth data for the identified cropped region of the spatial representation.

11. The method of claim 2, further comprising:
determining at least a second gaze convergence distance of the user,
wherein the first depth region of the spatial representation is identified corresponding to obtained depth data within a range based on said determined gaze convergence distance and the determined at least second gaze convergence distance of the user.

12. The method of claim 7, further comprising:
determining a new gaze point of the user;
on condition that the determined new gaze point is within the identified cropped region, identifying a new cropped region being the same as the identified cropped region; or
on condition that the determined new gaze point is outside the identified cropped region, identifying a new cropped region including the determined new gaze point and being different from the identified cropped region.

13. The method of claim 7, wherein consecutive gaze points of the user are determined in consecutive time intervals, respectively, further comprising, for each time interval:
determining if the user is fixating or saccading;
on condition the user is fixating, determining a refined gaze point; and
on condition the user is saccading, refraining from determining a refined gaze point.

14. The method of claim 7, wherein consecutive gaze points of the user are determined in consecutive time intervals, respectively, further comprising, for each time interval:
determining if the user is in smooth pursuit; and
on condition the user is in smooth pursuit, identifying consecutive cropped regions including the consecutive gaze points, respectively, such that the identified consecutive cropped regions follow the smooth pursuit.

15. The method of claim 1, wherein the spatial representation is an image.

16. A head mounted device for determining a gaze point of a user comprising a processor and a memory, said memory containing instructions executable by said processor, whereby said head mounted device is operative to:
determine a gaze convergence distance of the user;
obtain a spatial representation of at least a part of a field of view of the user;
obtain depth data for at least a part of the spatial representation;
determine saliency data for the spatial representation based on the determined gaze convergence distance and the obtained depth data; and
determine a refined gaze point of the user based on the determined saliency data.

17. The head mounted device of claim 16, further comprising one of a transparent display and a non-transparent display.

18. A computer program, comprising instructions which, when executed by at least one processor, cause the at least one processor to:
determine a gaze convergence distance of the user;
obtain a spatial representation of a field of view of the user;
obtain depth data for at least a part of the spatial representation;
determine saliency data for the spatial representation based on the determined gaze convergence distance and the obtained depth data; and
determine a refined gaze point of the user based on the determined saliency data.

19. A carrier comprising a computer program according to claim 18, wherein the carrier is one of an electronic signal, optical signal, radio signal, and a computer readable storage medium.
